(19) United States
(12) Patent Application Publication
(10) Pub. No.: US 2020/0259194 A1
(43) Pub. Date: Aug. 13, 2020

(54) METHOD FOR REMOVING PRODUCT WATER FROM A FUEL CELL

(71) Applicant: Robert Bosch GmbH, Stuttgart (DE)

(72) Inventor: Michael Deibler, Moeglingen (DE)

(21) Appl. No.: 16/758,534

(22) PCT Filed: Oct. 11, 2018
(86) PCT No.: PCT/EP2018/077676

§ 371 Date: Apr. 23, 2020

(30) Foreign Application Priority Data
Oct. 25, 2017 (DE) 10 2017 219 045.0

(51) Int. Cl. H01M 8/04119; H01M 8/0438

(52) U.S. Cl. CPC H01M 8/04179; H01M 2250/20; H01M 8/04388

(57) ABSTRACT

The invention relates to a method for removing product water from a fuel cell stack (12), which is associated with a collection container (16) and with a fuel injector (26), and to a fuel cell system (10). At least the following method steps are performed: a) detecting a control value of the fuel injector (26) prior to an opening time (42) of a discharge valve (30) on the collection container (16); b) opening the discharge valve (3) and pressing out product water from the fuel cell stack (12) and the collection container (16) by the fuel pressure applied via the fuel injector (26); c) detecting a control value increase (82) of the fuel injector (26) by an absence of the counter-pressure of already pressed-out product water; and d) closing the discharge valve (30) at a closing time (74), which coincides with the time at which the control value increase (82) of the fuel injector (26) is detected in accordance with method step c).

### BACKGROUND

The invention concerns a method for removing product water from a fuel cell, in particular from a fuel cell stack. Furthermore, the invention relates to a fuel cell system.

Fuel cell systems, which are used as drives in an FCV (Fuel Cell Vehicle) or as stationary systems, produce product water during operation, preferably on the anode side. This product water is usually collected in a collection container, which is emptied at certain intervals. It should be noted that a collection container that is too full can flood the fuel cell stack from the bottom and thus damage it. However, if an emptying valve, which is assigned to the collection container, is opened for too long, after the complete discharge of the product water collected therein fuel such as hydrogen also flows out of the fuel cell stack. This in turn reduces the achievable range of an FCV and thus reduces the efficiency of the fuel cell system.

One possibility for remedying this is to place one or two level sensors in the collection container in order to detect both states, in particular a “collection container completely filled” state or at least the “collection container completely emptied” state.

Detecting the “collection container completely emptied” state via a pressure drop on the anode side has been tried.

Other possible remedies are needed for fuel cell systems where a pressure drop cannot be detected due to other structural properties.

### SUMMARY

For the representation of collection container emptying, according to the invention a method is proposed for emptying product water from a fuel cell stack, to which a collection container and a fuel injector are assigned, with which at least the following method steps are carried out:
a) Detecting a control value of a fuel injector before an opening time of a discharge valve on the collection container,
b) Opening the discharge valve and pressing out product water from the fuel cell stack by the fuel pressure applied by the fuel injector,
c) Detecting an increase in the fuel injector control value due to a lack of counterpressure of the already expelled product water;
d) Closing the discharge valve at a closing time which coincides with the time of detecting the increase in the fuel injector control value in accordance with method step c).

By this solution it can be achieved in an advantageous way that removal of the product water can be realized without further apparatus cost that goes beyond the apparatus cost already applied to the fuel cell system. The fuel pressure that is applied to the fuel cells is exploited in an advantageous manner for this purpose, wherein it is fed to the fuel cell, which is preferably supplied with gaseous hydrogen. Due to the constant exposure of the fuel cell stack to the gaseous fuel, which is under a certain pressure, this applied pressure can be used to press out product water at regular intervals. With the method proposed according to the invention, in particular resulting product water on the anode side is driven from the fuel cell stack. Following the method proposed according to the invention, after the complete emptying of the collection container the fuel injector control value is reset to the control value that the control value had according to method step a), in which the fuel injector control value was detected before an opening time of a discharge valve.

According to the invention, it is further proposed that the product water pressed out of the collection container is initially discharged via a discharge pipe, which branches off from the collection container, wherein this discharge pipe advantageously opens at a branch into an exhaust air pipe of the fuel cell stack. As a result, no further apparatus, in particular no further piping of the fuel cell system is required, in that already existing components can be used.

Following the method proposed according to the invention further, the pressure curve within the fuel cell stack is continuously detected by means of at least one pressure sensor. The at least one pressure sensor is located in particular within a recirculation path for the fuel, which is usually gaseous hydrogen.

In an advantageous manner, after the complete emptying of the collection container a pressure minimum is detected at the time in the pressure curve of the fuel cell stack at a closing time of the discharge valve. The detected pressure medium in the pressure curve of the fuel cell stack could alternatively also be used to open the discharge valve of the collection container.

The invention also concerns a fuel cell system, for example of an FCV (Fuel Cell Vehicle) with at least one fuel cell stack, whose product water is expelled according to the inventive method.

The advantages of the solution proposed according to the invention are to be seen in that in fuel cell systems having a fuel cell stack, which is continuously supplied with gaseous fuel, in particular gaseous hydrogen, via a fuel injector, the prevailing pressure can be exploited to expel the resulting product water on the anode side from the fuel cell stack via the collection container. On the one hand, this prevents the fuel cell stack from being gradually flooded from the bottom by an overflowing collection container; on the other hand, the solution proposed according to the invention reliably prevents further gaseous fuel, in particular gaseous hydrogen, from escaping from the fuel cell stack after emptying the product water, although the product water has already been completely emptied from the collection container.

Moreover, a reduction of the sensor system for full/empty detection can be achieved by the solution proposed according to the invention. By reducing the sensor system, the error event whereby defective sensors could cause the system to malfunction can be ruled out. By the solution proposed according to the invention, moreover, drying out of the fuel cell stack in the event of excessive and excessively long-lasting hydrogen discharge into the discharge container can be avoided. Systems that do not require sensors usually have longer emptying intervals to prevent the fuel cell stack from being flooded by product water and thus losing gaseous hydrogen due to drying out. By the solution proposed according to the invention, furthermore a reduction of outflowing hydrogen can be avoided and the formation of an explosive mixture in the exhaust air path can be excluded.

### BRIEF DESCRIPTION OF THE DRAWINGS

Based on the drawing, the invention is described in more detail below.

In the figures:

FIG. 1 shows a fuel cell system with at least one fuel cell stack in a schematic representation,

FIG. 2 shows a pressure curve in a fuel cell stack when emptying the collection container without pressure control,

FIG. 3 shows a pressure curve in the fuel cell stack with a pressure control by means of a fuel injector assigned to the fuel cell stack and

FIG. 4 shows a pressure curve in the fuel cell stack with a pressure control on the fuel injector with a shorter discharge valve opening time span.

### DETAILED DESCRIPTION

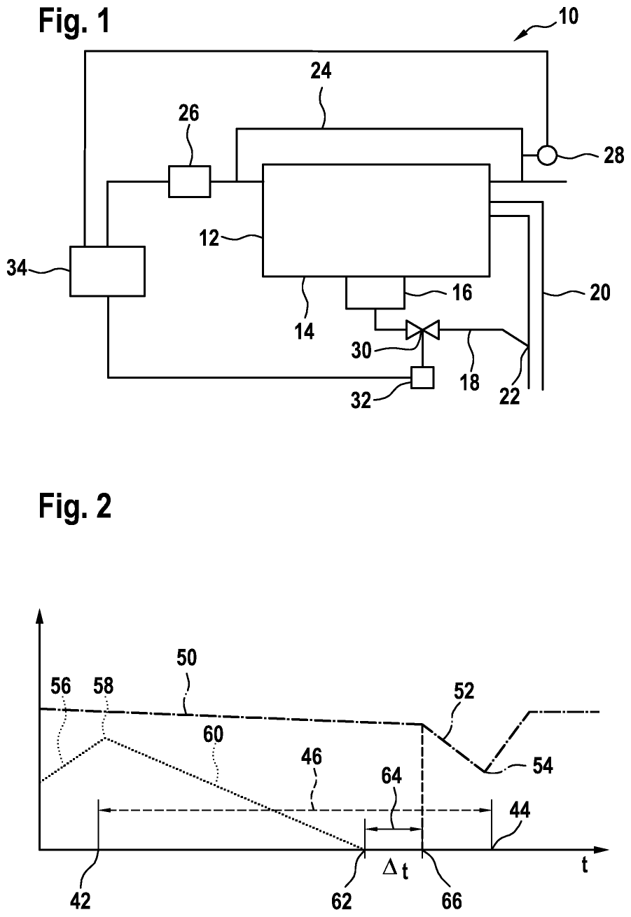

FIG. 1 is a schematic representation of a fuel cell system of an FCV′ (Fuel Cell Vehicle).

A fuel cell system 10 comprises at least one fuel cell stack 12. This comprises on its underside a stack bottom 14, on which a collection container 16 is arranged for collecting product water. A discharge pipe 18 which extends from the collection container 16 opens into an exhaust air pipe 20, which advantageously branches off from the at least one fuel cell stack 12, at an opening point 22. The at least one fuel cell stack 12 is provided with a fuel injector 26, which is located in the upper region of at least one fuel cell stack 12 and via which pressurized gaseous fuel, in particular gaseous hydrogen, passes into the at least one fuel cell stack 12 of the fuel cell system 10. Furthermore, a recirculation path 24 for gaseous fuel is shown in the upper region of at least one fuel cell stack 12. In this there is at least one pressure sensor 28, by means of which the pressure of the gaseous fuel in the recirculation path 24 and thus in the at least one fuel cell stack 12 can be detected.

A discharge valve 30, which is placed in the collection container 16, which is usually located below the stack bottom 14 of at least one fuel cell stack 12, can be advantageously operated by means of a valve controller 32.

Moreover, the fuel cell system 10 shown schematically in FIG. 1 comprises a control unit 34. This is connected to the at least one pressure sensor 28 and captures its signals; further, the control unit 34 is connected to the fuel injector 26 and to the valve controller 32, by means of which the discharge valve 30, which is assigned to the collection container 16 for product water, is actuated.

FIG. 2 shows an emptying of a collection container 16 of a fuel cell system 10 without pressure control.

FIG. 2 shows that the discharge valve 30, which is assigned to the collection container 16, is opened at an opening time 42. Until the opening of the discharge valve 30 at the opening time 42, there has been a continuous level increase 56 of the product water in the collection container 16. The level increase 56 reaches a maximum level 58, at which the discharge valve opens 30. There is an emptying of 60 of the collection container 16 of product water, which comes to an end at time 62, i.e. when the collection container 16 is completely emptied of product water.

The beginning of a pressure drop 52 in the fuel cell stack 12 takes place at time 66 with a delay 64 relative to the time 62 at which the collection container 16 is completely emptied according to a pressure curve 50 within the at least one fuel cell stack 12. This is due to the fact that during the delay 64 after complete emptying of the collection container 16 at time 62, fuel flows via the still open discharge valve 30 and via the collection container 16 into the discharge pipe 18 and thus out of the at least one fuel cell stack 12. According to the representation in FIG. 2, after an opening period 46, during which the discharge valve 30 is opened, this is closed at a time 44. At the time 44 of the closing of the discharge valve 30, the pressure within the fuel cell stack 12 according to the pressure curve 50 reaches its minimum 54. Only with the closing of the discharge valve 30 will the outflow of gaseous fuel from the at least one fuel cell stack 12 be stopped.

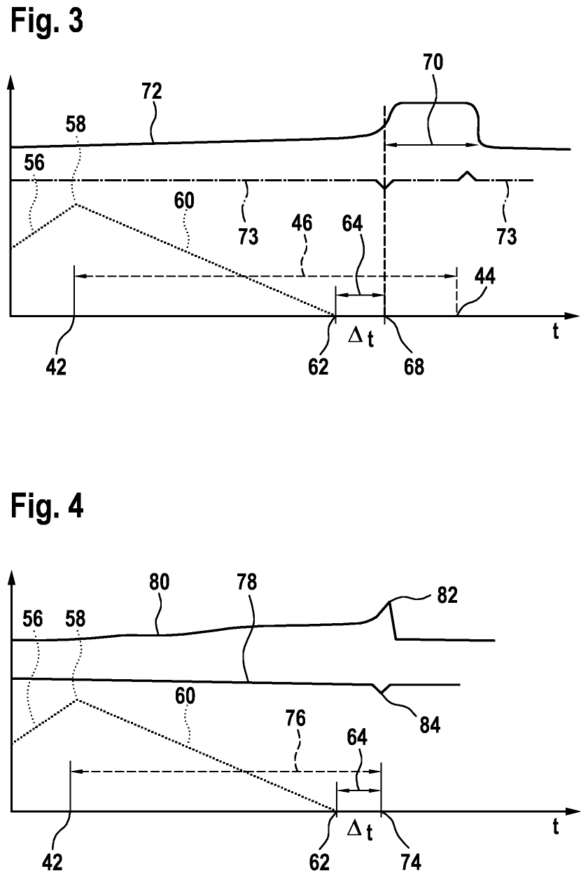

FIG. 3 shows a graphical representation of the method proposed according to the invention for emptying product water from at least one fuel cell stack 12 with pressure control.

From the representation according to FIG. 3, it is shown that the at least one fuel cell stack 12 is continuously supplied by means of the fuel injector 26 with gaseous fuel, which is usually gaseous hydrogen, with a corresponding pressure level. The pressure level prevailing in the at least one fuel cell stack 12 is represented by a pressure curve 73 in the representation according to FIG. 3. In contrast to the representation according to FIG. 2, in the graphic representation according to FIG. 3 pressure control in the at least one fuel cell stack 12 is carried out by means of the fuel injector 26 shown in FIG. 1. The control curve thereof is represented by reference character 72 in the graphic representation according to FIG. 3. According to FIG. 3, the discharge valve 30 of the collection container 16 opens at the opening time 42. Up to the time 44, the discharge valve 30 is open during the opening period 46. The level in the collection container 16 has risen to the maximum level 58 according to the level increase 56. At the opening time 42 the discharge valve 30 opens, so that product water flows continuously from the collection container 16 according to the emptying 60 and is removed from the fuel cell system 10 via the discharge pipe 18 and the exhaust air pipe 20 shown in FIG. 1. At time 62, the collection container 16 is completely emptied, however the discharge valve 30 is fully open at this time, i.e. at time 62.

Starting from time 62, an increase in the control value according to the control curve 72 of the fuel injector 26 takes place at a time 68 after a delay 64. By this means, the outflow of gaseous fuel from at least one fuel cell system 10 via the still open discharge valve 30 is therefore compensated by the addition of additional gaseous fuel, which takes place according to a period 70. With closing of the discharge valve 30 at time 44, after completion of the discharge valve 30 opening period 46, the control value of the fuel injector 26 decreases according to the control curve 72 in FIG. 3.

A graphical representation of the emptying of the collection container 16 on at least one fuel cell stack 12 of a fuel cell system 10 with pressure control and a shortened opening time span 46 of the discharge valve 30 can be seen in the representation according to FIG. 4.

Analogous to the representation according to FIG. 3, the discharge valve opens at a time 42, so that starting from a maximum level 58 after a level rise 56 in the collection container 16, continuous emptying 60 thereof is carried out until a time 62 at which the collection container 16 is completely emptied of product water.

According to a pressure curve 80, which represents a second control curve of the fuel injector 26, after complete emptying of the collection container 16 of product water at time 62, an increase in the control value takes place according to the second control curve 80 up to a control value maximum 82. The increase of the control value to the maximum 82 according to FIG. 4 is detected by a control unit 34. The increase in the control value according to the second control curve 80 up to the control value maximum 82 is caused by the control value maximum 82 being detected due to the lack of counterpressure due to the product water, which has been completely emptied from the collection container 16 up to the time 62, and a control algorithm implemented in the control unit 34 therefore increases the control value for the fuel injector 26. This increase in the control value to the control value maximum 82 according to the second control curve 80 in FIG. 4 is detected by the control unit 34 and causes closing of the opened discharge valve 30 by the valve controller 32 at the closing time 74.

The closing time 74 and an associated shortened opening time 76 of the discharge valve 30 is significantly shorter than the opening time 46 of the discharge valve 30 shown in FIGS. 2 and 3.

As further shown in FIG. 4, starting from time 62, following a delay 64 a pressure minimum 84 is set in the pressure curve 78 within the at least one fuel cell stack 12, which could also be used by the control unit 34 as a signal for closing the discharge valve 30 by means of corresponding control of the valve controller 32.

The invention also concerns a fuel cell system 10, which comprises at least one fuel cell stack 12, which according to the method described above can be emptied of product water, in particular product water or other moisture produced on the anode side, so that an outflow of gaseous fuel, in particular gaseous hydrogen, after emptying the collection container 16 can be avoided, thereby wetting of the fuel cell stack 12 from the stack bottom 14 can be avoided and in particular the undesirable outflow of gaseous fuel from the at least one fuel cell stack 12, which can result in a highly undesirable efficiency reduction and a highly unacceptable shortening of a maximum range of an FCV, can be prevented.

The invention is not limited to the exemplary embodiments described here and the aspects highlighted therein. Rather, within the scope indicated by the claims, a large number of variations are possible, which lie within the framework of action by a person skilled in the art.

1. A method for removing product water from a fuel cell stack (12), to which a collection container (16) and a fuel injector (26) are assigned, the method comprising:
a) Detecting a fuel injector control value (26) before an opening time (42) of a discharge valve (30) on the collection container (16),
b) Opening the discharge valve (30) and pressing out product water from the fuel cell stack (12) by the fuel pressure applied by the fuel injector (26),
c) Detecting an increase in the control value (82) of the fuel injector (26) due to a lack of counterpressure of product water already pressed out,
d) Closing the discharge valve (30) at a closing time (74) which coincides with the time of detecting the increase in the control value (82) at the fuel injector (26) according to method step c).

2. The method as claimed in claim 1, characterized in that product water accumulating on an anode side is pressed out of the fuel cell stack (12).

3. The method as claimed in claim 1, characterized in that with method step d) the control value of the fuel injector (26) is reset to a control value of the fuel injector (26) similar to a control value detected in accordance with method step a).

4. The method as claimed in claim 1, characterized in that the product water pressed out of the collection container (16) is discharged via a discharge pipe (18).

5. The method as claimed in claim 1, characterized in that a respective pressure curve (50, 73, 80) in the fuel cell stack (12) is detected by at least one pressure sensor (28).

6. The method as claimed in claim 1, characterized in that a respective pressure curve (50, 73, 80) in the fuel cell stack (12) is detected within a recirculation path (24) for fuel on the fuel cell stack (12).

7. The method as claimed in claim 1, characterized in that after a complete emptying (60) of the collection container (16) at a time (62), a pressure minimum of a pressure curve (78) of the fuel cell stack (12) and an increase in the detected control value of the fuel injector (26) is detected at the closing time (74) of the discharge valve (30).

8. A fuel cell system (10) for an FCV (Fuel Cell Vehicle) with at least one fuel cell stack (12), the product water of which is expelled according to the method as claimed in claim 1.
